(19) United States
(12) Patent Application Publication
(10) Pub. No.: US 2009/0113023 A1
(43) Pub. Date: Apr. 30, 2009

(54) Method and System for Transmitting Data between Digital Photo Frames

(76) Inventor: Yu-Tsung Chang, Jhunan Township (TW)

Correspondence Address: HDLS Patent & Trademark Services, P.O. BOX 220746, CHANTILLY, VA, 20153-0746, US

(21) Appl. No.: 12/014,836

(22) Filed: Jan. 16, 2008

(30) Foreign Application Priority Data
Oct. 29, 2007 (TW) 096140645

(51) Int. Cl. H04L 12/28; G06F 15/16

(52) U.S. Cl. 709/218; 709/219; 709/228

(57) ABSTRACT

A method and a system for transmitting data between DPFs of which a first DPF has a first list configured for storing ID information of a second DPF includes transmitting directly image data from the first DPF to the second DPF when the first DPF detects the second DPF is online according to the ID information stored in the first list. It employs a more convenient way to transmit the image data between the DPFs.

### 1. FIELD OF THE INVENTION

The present invention relates to methods and systems for transmitting data between DPFs (Digital Photo Frames), and more specifically, to a method and system for directly transmitting data between DPFs.

### 2. DESCRIPTION OF THE RELATED ART

With the rapid development of the digital electronic technology, DPFs are used widely. When the DPFs are used, it may need to exchange image data stored in the different DPFs, or transmit image data stored in a DPF to another DPF. Conventional methods are usually connecting the DPF and a PC (Personal Computer), transmitting and storing the image data into the PC for exchanging or transmitting.

Referring to FIG. 1, a conventional system 100 for transmitting data between DPFs, is shown. The conventional system 100 includes DPFs 110, 120 and PCs 112, 122. The DPF 110 connects with the PC 112 through a data transmitting line 116. The DPF 120 connects with the PC 122 through a data transmitting line 126. The PC 112 connects with the PC 122 through a network 118. The network 118 may be the Internet or an area network. When transmitting or exchanging image data between the DPFs 110 and 120, the image data of the DPFs 110 and 120 are respectively stored in the PCs 112 and 122, and the PCs 112 and 122 respectively obtain the needed image data through the network 118 and then transmit the needed image data respectively to the DPFs 110 and 120.

Referring to FIG. 2, another conventional system 102 for transmitting data between DPFs, is shown. The conventional system 102 includes DPFs 150, 154 and a PC 152. The DPFs 150, 154 connects to the PC 150 respectively through data transmitting lines 156 and 146. When transmitting or exchanging the image data between the DPFs 150, 154, the image data of the DPFs 150, 154 are stored in the PC 152, and the PC 152 distributes the image data stored therein and transmits the image data respectively to the DPFs 150 and 154.

The conventional systems for transmitting data between DPFs, need the PCs to transmit or exchange the image data between the DPFs, and cannot directly transmit or exchange the image data between the DPFs, no matter the DPFs have a long distance or a short distance therebetween.

What is needed are a method and a system for directly transmitting data between the DPFs.

### BRIEF SUMMARY

An object of the present invention is to provide a method for transmitting data between DPFs, which is configured for directly transmitting image data between the DPFs.

Another object of the present invention is to provide a system for transmitting data between DPFs, which is configured for directly transmitting image data between the DPFs.

A method for transmitting data between DPFs in accordance with a preferred embodiment of the present invention, where a first DPF has a first list configured for storing ID information of a second DPF, includes directly transmitting image data from the first DPF to the second DPF when the first DPF detects the second DPF online according to the ID information stored in the first list.

A system for transmitting data between DPFs in accordance with another preferred embodiment of the present invention includes a first DPF having a first list, a second DPF connected to the first DPF via a data transmitting media to be configured for communicating the first DPF and the second DPF. The first list is configured for storing ID information of the second DPF, and the first DPF directly transmits image data to the second DPF when the first DPF detects the second DPF online according to the ID information stored in the first list.

The present method and system for transmitting data between DPFs includes the first DPF having a list configured for storing the ID information of the second DPF. The first DPF may directly transmit the image data to the second DPF when the first DPF detects the second DPF online according to the ID information of the second DPF stored in the list. Therefore, compared with the conventional art, the present method and system may employ a more convenient way to transmit the image data between the DPFs.

Other objects, advantages and novel features of the invention will become more apparent from the following detailed description when taken in conjunction with the accompanying drawings, in which:

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a conventional system for transmitting data between DPFs;

FIG. 2 is a schematic view of another conventional system for transmitting data between DPFs;

FIG. 3 is a schematic view of a system for transmitting data between DPFs of a first preferred embodiment of the present invention;

FIG. 4 is a schematic view of a system for transmitting data between DPFs of a second preferred embodiment of the present invention;

FIG. 5 is a schematic view of a system for transmitting data between DPFs of a third preferred embodiment of the present invention; and

FIG. 6 is a schematic view of a system for transmitting data between DPFs of a fourth preferred embodiment of the present invention.

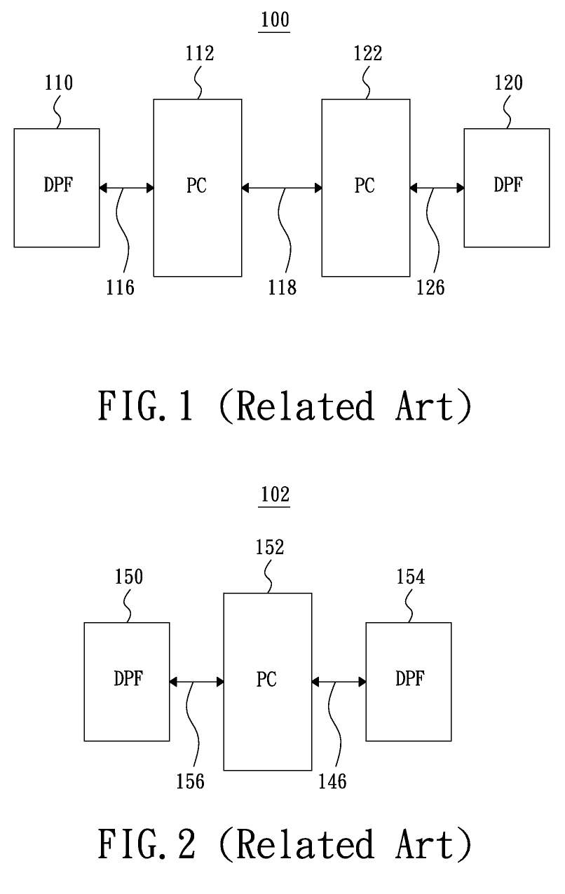

### DETAILED DESCRIPTION

Reference will now be made to the drawings to describe a preferred embodiment of the present method and system for transmitting data between DPFs, in detail.

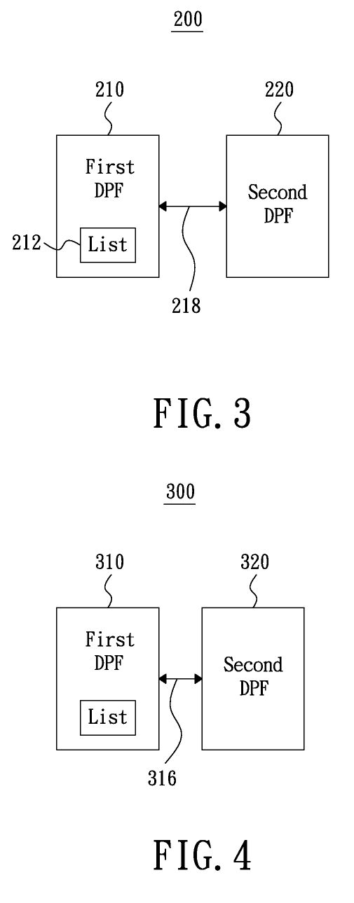

Referring to FIG. 3, a system 200 for transmitting data between DPFs in accordance with a first preferred embodiment of the present invention is shown. The system 200 includes a first DPF 210 and a second DPF 220. The first DPF 210 and the second DPF 220 are connected through a network 218. The first DPF 210 includes a list 212 configured for storing ID information of the second DPF 220. The first DPF 210 receives the information through the network 218, and detect whether the second DPF 220 is online according to the ID information stored in the list 212. If the first DPF 210 detects that the second DPF 220 is online, the first DPF 210 will directly transmit image data to the second DPF 220 through the network 218. The network 218 may be Internet or an area network. The first DPF 210 may employ an instant messaging software and the ID information of the second DPF 220 stored in the list 212 to detect whether the second DPF 220 is online.

In the present system 200 for transmitting data between DPFs, the first DPF 210 includes the list 212 configured for storing the ID information of the second DPF 220. When the first DPF 210 detects the second DPF 220 is online according to the ID information stored in the list 212, the first DPF 210 directly transmit the image data to the second DPF 220 through the network. Therefore, compared with the conventional art, the present system 200 employs a more convenient way to transmit the image data between the first DPF 210 and the second DPF 220.

Referring to FIG. 4, a system 300 for transmitting data between DPFs in accordance with a second preferred embodiment of the present invention is shown. The system 300 is same to the system 200 of the first preferred embodiment, except that in the system 300, the first DPF 310 and the second DPF 320 are connected through a data transmitting line 316. The operating theory of the system 300 is similar to that of the system 200. Therefore, compared with the conventional art, the system 300 for transmitting data between DPFs may employ a more convenient way to transmit the image data between the first DPF 310 and the second DPF 320.

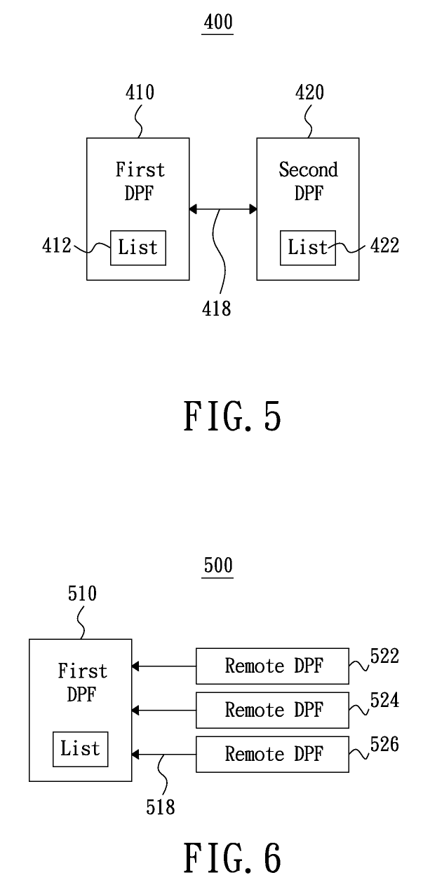

Referring to FIG. 5, a system 400 for transmitting data between DPFs in accordance with a third preferred embodiment of the present invention is shown. The system 400 includes a first DPF 410 and a second DPF 420. The first DPF 410 and the second DPF 420 are connected through a network 418. The first DPF 410 includes a list 412 configured for storing ID information of the second DPF 420. The second DPF 420 includes a list 422 configured for storing ID information of the first DPF 410. The first DPF 410 and the second DPF 420 employ an instant messaging software and the lists 412 and 422 to detect respectively whether the first DPF 410 and the second DPF 420 are online for each other. If the first DPF 410 and the second DPF 420 detect each other are online, the first DPF 410 and the second DPF 420 directly transmit or exchange image data. The network 418 may be Internet or an area network.

Compared with the conventional art, the present system 400 for transmitting data between DPFs may employ a more convenient way to transmit or exchange the image data between the first DPF 410 and the second DPF 420.

Referring to FIG. 6, a system 500 for transmitting data between DPFs in accordance with a fourth embodiment of the present invention is shown. The system 500 of the fourth preferred embodiment is same to the system 200 of the first embodiment, except that in the system 500, the first DPF 510 employs the network 518 to connect with a plurality of remote DPFs 522, 524, and 526. When the first DPF 510 detects any of the plurality of remote DPFs is online according to the ID information stored in the list, the first DPF 510 may employ the network 518 to transmit or exchange the image data to the DPF that is online. The plurality of remote DPFs 522, 524 and 526 may have a same structure to the second DPF 220 of the first preferred embodiment, or have a same structure to the second DPF 420 of the third preferred embodiment. Or some of the plurality of remote DPFs 522, 524 and 526 may have a same structure to the second DPF 220 of the first preferred embodiment, and the others thereof have a same structure to the second DPF 420 of the third preferred embodiment. Of course, the amount of the plurality of remote DPF can be decided by need. The network 518 may be Internet or an area network.

Compared with the conventional art, the system 500 for transmitting data between DPFs may employ a convenient way to transmit or exchange the image data between the DPFs.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method for transmitting data between DPFs (Digital Photo Frames), comprising:
making a first DPF with a first list configured for storing ID information of a second DPF; and
directly transmitting image data from the first DPF to the second DPF when the first DPF detects the second DPF is online according to the ID information stored in the first list.

2. The method as claimed in claim 1, wherein the first DPF employs an instant messaging software to detect whether the second DPF is online according to the ID information of the second DPF stored therein.

3. The method as claimed in claim 1, wherein the first DPF connects to the second DPF via a network, and the first DPF directly transmits the image data to the second DPF via the network.

4. The method as claimed in claim 1, wherein the first DPF connects to the second DPF via a data transmitting line, and the first DPF directly transmits the image data to the second DPF via the data transmitting line.

5. The method as claimed in claim 1, wherein the first list stores ID information of a plurality of remote DPFs.

6. The method as claimed in claim 5, further comprising:
directly transmitting the image data from the first DPF to one of the plurality of remote DPFs online when the first DPF detects the one of the plurality of remote DPFs online according to the ID information of the plurality of remote DPFs.

7. The method as claimed in claim 1, further comprising:
making the second DPF with a second list configured for storing ID information of the first DPF; and
directly exchanging the image data between the first DPF and the second DPF when the first DPF and the second DPF detect each other are online.

8. A system for transmitting data between DPFs (Digital Photo Frames), comprising:
a first DPF having a first list;
a second DPF connected to the first DPF via a data transmitting media to be configured for communicating the first DPF and the second DPF; and
wherein the first list is configured for storing an ID information of the second DPF, and the first DPF directly transmits image data to the second DPF when the first DPF detects the second DPF is online according to the ID information stored in the first list.

9. The system as claimed in claim 8, wherein the first DPF employs an instant messaging software to detect whether the second DPF is online according to the ID information of the second DPF stored therein.

10. The system as claimed in claim 8, wherein the first DPF connects to the second DPF via a network, and the first DPF directly transmits the image data to the second DPF via the network.

11. The system as claimed in claim 8, wherein the first DPF connects to the second DPF via a data transmitting line, and the first DPF directly transmits the image data to the second DPF via the transmitting line.

12. The system as claimed in claim 8, further comprising a plurality of remote DPFs connected to the first DPF, and the first list including ID information of the remote DPFs.

13. The system as claimed in claim 12, wherein the first DPF is capable of directly transmitting the image data to one of the remote DPFs when the first DPF detects the one of the remote DPFs online according to the ID information of the remote DPFs.

14. The system as claimed in claim 8, wherein the second DPF includes a second list configured for storing ID information of the first DPF, and the first DPF and the second DPF is capable of directly exchanging the image data when the first DPF and the second DPF detect each other are online.
